(19) United States
(12) Patent Application Publication
(10) Pub. No.: US 2006/0035616 A1
(43) Pub. Date: Feb. 16, 2006

(54) Wireless data communication device

(76) Inventor: Wayne Pleasant, Turners Falls, MA (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/202,746

(22) Filed: Aug. 12, 2005

Related U.S. Application Data
(60) Provisional application No. 60/600,996, filed on Aug. 12, 2004.

(51) Int. Cl. H04B 1/26; H04M 1/00

(52) U.S. Cl. 455/313; 455/550.1

(57) ABSTRACT

A radio communication device is disclosed. A millimeter range mixer having a first immediate frequency port, a second reference port, and a millimeter wave port receives an intermediate frequency radio signal. A local oscillator source provides a reference signal to the reference port of the mixer, and using a millimeter wave filter coupled to the millimeter wave port of the mixer, the intermediate frequency radio signal is converted to a millimeter wave frequency signal.

### CROSS-REFERENCE TO RELATED APPLICATIONS

This application is a nonprovisional of U.S. Provisional Patent Application No. 60/600,996, filed Aug. 12, 2004, now pending. Priority to this application is claimed under 35 U.S.C. §§ 119, and the disclosure of this application is incorporated herein by reference in its entirety.

### TECHNICAL FIELD

The invention relates to a wireless data communication device that extends the operating carrier frequency of devices such as wireless Local Area Network (“LAN”) equipment to the millimeter wave frequency band.

### BACKGROUND OF THE INVENTION

Computer systems such as personal computers, notebook computers, laptop computers, computer terminals, personal digital assistants (“PDAs”) and other data processing units may be interconnected via a particular type of wireless data network, a Wireless Local Area Network (“wireless LAN”). In such a configuration, terminal devices include a communication controller such as a Media Access Controller (“MAC”) to interface data processing equipment and a wireless transceiver. The controller selects the radio channel at which the radio transceiver operates, organizes data for transmission and reception across the wireless LAN, and performs error correction and other functions.

Typically, the transceiver used by these devices to communicate via the wireless LAN is a superheterdyne radio frequency (“RF”) device. In the conventional transceiver, an antenna receives signals and provides them to a bandpass RF filter, or diplexer, that selects only the RF signals and radio noise within a predetermined bandwidth of interest. Radio noise outside of the predetermined bandwidth of interest are attenuated. The selected RF signals and noise are amplified by a noise amplifier prior to conversion to an Intermediate Frequency (“IF”) by the receiver mixer.

When transmitting, a converter passes signals to one or more output transmit filters. These filters, also known as the “transmit side” of the diplexer, attenuate those signals outside of a desired predetermined transmit bandwidth. A power amplifier may also be used to amplify signals before or after those signals are received by the transmit filters.

Wireless LAN equipment is easy to deploy since it eliminates the need for connecting cables and wires to each network device. Thus, not only do wireless laptops have access to a wireless LAN, but deploying desktops and other workstations is easier as well. Indeed, the popularity of wireless LAN equipment has grown so rapidly that frequently in urban areas, two or more wireless LAN signals intersect each other at multiple points. In urban areas where the computing equipment of different companies or people is in close proximity to each other, this intersection phenomenon of two or more wireless LAN signals is becoming increasingly frequent. Thus, a need has arisen for extending the radio frequency range at which wireless data communication devices communicate.

The present invention is provided to solve the problems discussed above and other problems, and to provide advantages and aspects not provided by prior systems of this type. A full discussion of the features and advantages of the present invention is deferred to the following detailed description, which proceeds with reference to the accompanying drawings.

### SUMMARY OF THE INVENTION

The present invention is a device herein referred to as a “transconverter” that is easily coupled to existing final stage radio equipment in a wireless LAN transceiver. The transconverter up-converts transmitted WLAN signals and down-converts received WLAN signals to and from a millimeter wave frequency band. The resulting wireless signals, being located in a millimeter wave frequency band far away from the more traditional unlicensed wireless LAN frequency bands, do not interfere with signals from other devices.

More particularly, the transconverter is a type of single-ended transceiver that makes use of a bi-directional 1F-to-millimeter wave converter. This specifically includes a local oscillator source, and a frequency multiplier that are coupled to one terminal of a single balanced mixer. The other two terminals of the balanced mixer are coupled to a pre-modulated IF signal terminal and a millimeter wave frequency terminal. A filter associated with the mixer is coupled to the millimeter wave terminal that may be in turn coupled to an antenna. Optionally, a power amplifier or low noise amplifier module may be coupled between the filter and antenna.

For example, the transconverter may shift an input IEEE 802.11B compatible signal from an operating range of 2.4 GHz up to a millimeter wave frequency range in the 20 GHz band. However, it should be understood that other frequency ranges and multiply shifts can be used. For example, an 802.11A device operating in the 5.8 GHz band may be transconverted to 40 GHz or higher.

The power amplifier or low noise amplifier stage may take several forms. In one embodiment, where low-gain transmit signals are acceptable at the millimeter wave frequency, circulators may be used to isolate a power amplifier path from a low noise amplifier path. However, in such instances as where high power amplifiers are preferable, it is still useful to use the transconverter design of the present invention. In particular, these implementations may be used in a Time Division Duplex (“TDD”) signaling environment, wherein bias signals may control the operation of a power amplifier or low noise amplifier. In addition, a bi-static mode may be used to physically isolate the transmit and receive signal paths.

In a preferred embodiment, the transconverter of the present invention is conveniently packaged within a housing. The housing may contain standard 802.11 wireless LAN equipment such as packaged in PCMCIA-formatted circuit boards. The housing contains the transconverter electronics, but also the millimeter wave antenna, and a data processor interface port.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a block diagram of the transconverter, shown coupled to a wireless LAN transceiver according to the present invention.

FIGS. 2A, 2B, and 2C represent various implementations of the present invention wherein the millimeter wave frequency signals are of low power.

FIGS. 2D and 2E show possible design configurations of the present invention wherein high power operation is required.

FIG. 3 is an isometric view of a mechanical configuration for the transconverter of the present invention.

### DETAILED DESCRIPTION OF THE DRAWINGS

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

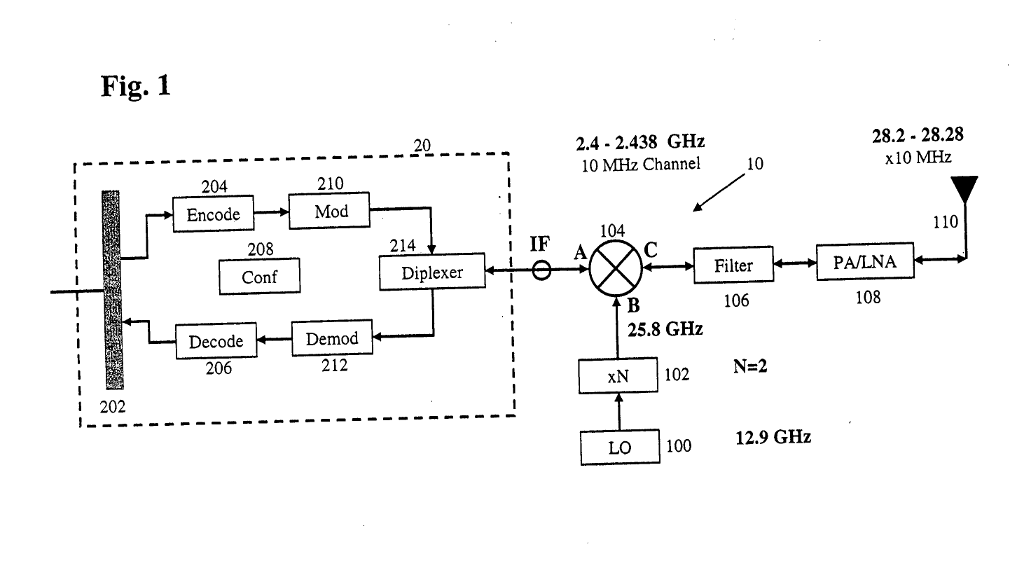

Referring to FIG. 1, there is shown a block diagram illustrating a transconverter 10 constructed in accordance with the principles of the present invention. The transconverter 10 is preferably assembled of a local oscillator source 100, frequency multiplier 102, balanced mixer 104, filter 106, and antenna 110. Optionally, a power amplifier/low noise amplifier (PA/LNA) 108 may also be coupled to the transconverter 10.

The transconverter 10 accepts an intermediate frequency signal at one input terminal of the mixer 104. The signal is converted up to a higher frequency by the filter 106, and passed to the antenna 110. Thus, the transconverter 10 can convert an input standard wavelength radio frequency signal to a millimeter range higher frequency signal.

In another embodiment of the present invention, the transconverter 10 accepts a non-standard millimeter range wavelength radio signal via the antenna 110. The signal is filtered through the filter 106, and is converted down to a standard wavelength signal via the balanced mixer 104. Thus, the transconverter 10 can convert an input millimeter range signal to a standard wavelength radio frequency signal.

The balanced mixer 104 is a three terminal device having a first terminal A that is associated with an intermediate frequency signal port, a second terminal B associated with a local reference signal, and a third terminal C associated with a millimeter wave port for the filter 106. The intermediate frequency signal fed to port A of the mixer 104 is a pre-modulated signal. In one instance of the present invention, the transconverter 10 works with a wireless local area network equipment where the standard signal is in the range of, for example, 2.4 to 2.483 GHz, such as in an IEEE 802.11B compliant environment. In a 802.11A compliant environment, the signal is typically near 5.8 GHz.

In a preferred embodiment, the transconverter 10 communicates with a wireless local area network modem 20. The model 20 includes a data processor interface 202, encoder 204, decoder 206, modulator 210, demodulator 212, diplexer 214, and controller 208. When the modem 20 is transmitting, signals are received from the data processing interface 202 and are fed to the signal encoder 204 and then to the modulator 210. This signal is then fed through the diplexer 214 to the intermediate frequency port, and typically then fed to a wireless network antenna.

When the modem 20 is receiving radio signals, the signal is fed from the antenna port to the diplexer 214 and then to the modulator 212, then to the decoder 206, and then to the interface 202. The controller 208 controls the encoder 204 and decoder 206, and the interface 202 to provide signals in a desired format to data processing equipment located at, for example, a personal computer. For example, the interface 202 may be an Ethernet-10 Base T port, 100 Base T, Gigabit Ethernet, or other suitable data processing interface.

The specific factor N by which the input signal is translated to a higher wavelength signal is chosen according to the desired separation in wavelength between the input and output signals. For example, if the multiply factor N is equal to 2, an input frequency signal of 12.9 GHz can be converted to an output signal of 25.8 GHz. The mixer thus produces the output millimeter wave signal in the 28.2 to 28.28 GHz range. It should be understood that other multiply factors can be used to shift input and output signals without departing from the principles of the present invention.

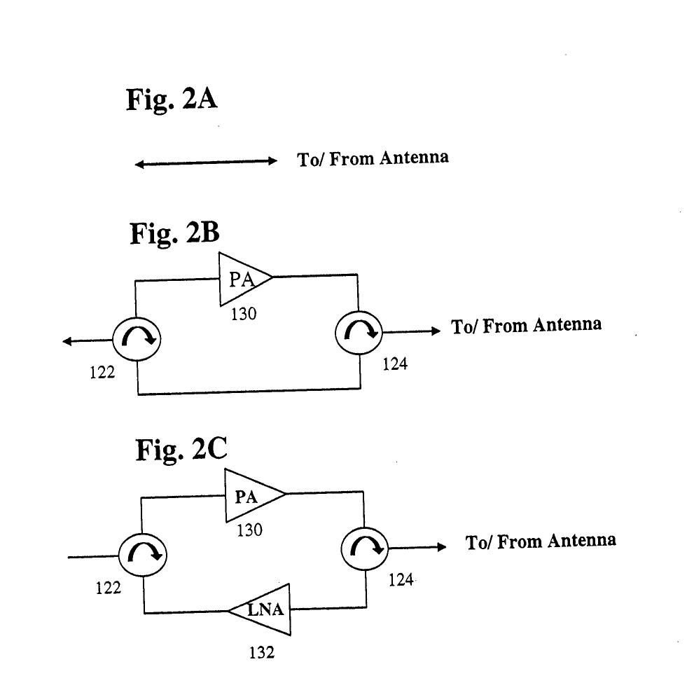

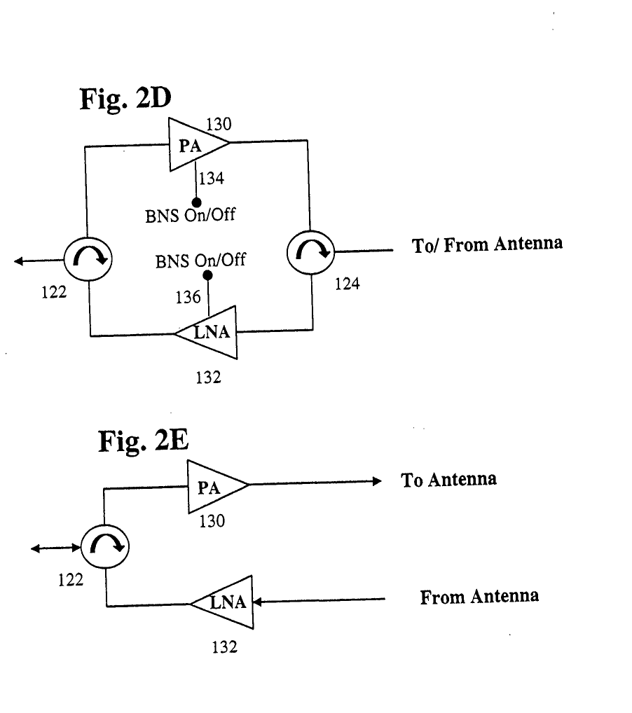

Referring now to FIG. 2D, there is shown a diagram of a system for providing a higher-power mode of operation of the present invention in which the signal paths are isolated. Through this system, operation in a Time Division Duplex mode is supported through the use of bias terminals 134, 136 coupled, respectively, to the power amplifier 130 and low noise amplifier 132. Alternatively, as illustrated in FIG. 2E, the output port of the power amplifier 130 and input port of the low noise amplifier 132 may be left uncoupled. In this embodiment, it is assumed that there are separate receive and transmit ports on the antenna and/or separate antennae for sending and receiving.

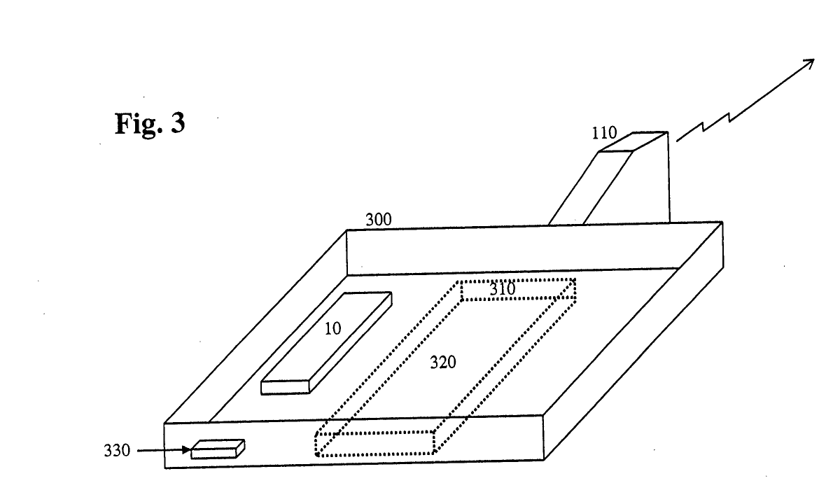

Referring now to FIG. 3, there is shown a housing for a transconverter 10 in accordance with the principles of the present invention. A housing 300 is constructed in which the transconverter 10 is seated. Preferably, the housing 300 also provides a mechanical support for the millimeter wave antenna 110. Preferably, the housing 300 has a coupler 310 which may be either mechanically or electrically arranged to receive a wireless local area network card 320. For example, the local area network card 320 may be a PCMCIA-type network card. Optionally, the housing 300 also houses a connector 300 associated with the data signal interface 202 for carrying signals to and from the data processing equipment.

While the specific embodiments have been illustrated and described, numerous modifications come to mind without significantly departing from the spirit of the invention, and the scope of protection is only limited by the scope of the accompanying claims.

What is claimed is:

1. A wireless data communication device comprising:
a millimeter range mixer having a first intermediate frequency port, a second reference port, and a third millimeter wave port;
an oscillator for providing a reference signal to the reference port of the mixer; and,
a millimeter wave filter coupled to the millimeter wave port of the mixer for converting an input intermediate frequency radio signal to a millimeter wave radio signal.

2. The device of claim 1, further comprising a power amplifier for amplifying the strength of the radio signal.

3. The device of claim 1, further comprising a low noise filter for amplifying the strength of the input radio signal.

4. The device of claim 1, further comprising an antenna for receiving and sending radio signals.

5. The device of claim 1, further comprising a multiplier for adjusting the reference signal.

6. A method for the conversion of radio signals, comprising the steps of:
receiving an input radio signal at an intermediate frequency port of a mixer;
providing a reference signal from an oscillator to a reference port of the mixer; and,
outputting an output millimeter wave radio signal from an output port of the mixer.

7. The method of claim 6, further comprising the step of:
amplifying the power of the output millimeter wave radio signal.

8. The method of claim 6, further comprising the step of:
filtering the input radio signal through a low noise amplifier.

9. The method of claim 6, further comprising the step of:
receiving the input radio signal from an antenna.

10. The method of claim 6, further comprising the step of:
transmitting the output millimeter wave radio signal to an antenna.

11. The method of claim 6, further comprising the step of:
adjusting the reference signal via a multiplier.

12. A wireless data communication device, comprising:
a millimeter range mixer having a first intermediate frequency port, a second reference port, and a third millimeter wave port;
an oscillator for providing a reference signal to the reference port of the mixer;
a millimeter wave filter coupled to the millimeter wave port of the mixer for converting an imputer frequency radio signal to a millimeter wave radio signal;
an antenna for receiving the intermediate frequency radio signal and transmitting the millimeter wave radio signal;
a power amplifier for amplifying the millimeter wave radio signal; and,
a low noise amplifier for amplifying the intermediate frequency radio signal.

13. A wireless data communication device comprising:
a millimeter range mixer having a first millimeter wave frequency port, a second reference port, and a third intermediate frequency wave port;
an oscillator for providing a reference signal to the reference port of the mixer; and,
a millimeter wave filter coupled to the millimeter wave port of the mixer for converting an input millimeter frequency radio signal to an intermediate wave radio signal.

14. The device of claim 13, further comprising a power amplifier for amplifying the strength of the input and output radio signals.

15. The device of claim 13, further comprising a low noise filter for amplifying the input and output radio signals.

16. The device of claim 13, further comprising an antenna for receiving and sending radio signals.

17. The device of claim 13, further comprising a multiplier for adjusting the reference signal.
